(19) United States
(12) Patent Application Publication
(10) Pub. No.: US 2024/0094876 A1
(43) Pub. Date: Mar. 21, 2024

(54) SCREENSHOT METHOD, ELECTRONIC DEVICE, AND COMPUTER PROGRAM PRODUCT THEREOF

(71) Applicant: ASUSTEK COMPUTER INC., TAIPEI (TW)

(72) Inventor: Shih-Han TANG, TAIPEI (TW)

(21) Appl. No.: 18/130,195

(22) Filed: Apr. 3, 2023

(30) Foreign Application Priority Data
Sep. 16, 2022 (TW) 111135038

(51) Int. Cl. G06F 3/0484

(52) U.S. Cl. CPC G06F 3/0484

(57) ABSTRACT

Disclosed is a screenshot method, applicable to an electronic device. The electronic device includes an input unit and a touch screen, and the touch screen is configured to display an image. The screenshot method includes: receiving a first screenshot signal using the input unit or the touch screen; taking a screenshot of the touch screen according to the first screenshot signal, and selectively enabling a successive screenshot function according to the first screenshot signal; and taking a screenshot of the touch screen according to a second screenshot signal when the successive screenshot function is enabled, where the second screenshot signal is different from the first screenshot signal. The disclosure further provides an electronic device and a computer program product.

### CROSS-REFERENCE TO RELATED APPLICATION

This application claims the priority benefit of Taiwan Application Serial No. 111135038, filed on Sep. 16, 2022. The entirety of the above-mentioned patent application is hereby incorporated by reference herein and made a part of specification.

### BACKGROUND OF THE INVENTION

### Field of the Invention

The disclosure relates to a screenshot method, and in particular, to a screenshot method for taking a screenshot of a touch screen, an electronic device, and a computer program product thereof.

### Description of the Related Art

With the rapid advancement of technology, human communication has shifted from original face-to-face conversation to interaction using instant messaging software. The action of capturing and sharing articles, interesting posts, video images, or the like has become an indispensable enjoyment of daily life.

However, when a user takes a screenshot for sharing, they need to keep their eyes on the screen of the phone throughout the entire process. The screenshot taking procedure is difficult and time-consuming, and also tends to cause interference to other operations of the user.

### BRIEF SUMMARY OF THE INVENTION

The disclosure provides a screenshot method, applicable to an electronic device. The electronic device includes an input unit and a touch screen, and the touch screen is configured to display an image. The screenshot method includes: receiving a first screenshot signal using the input unit or the touch screen; taking a screenshot of the image according to the first screenshot signal, and selectively enabling a successive screenshot function according to the first screenshot signal; and taking a screenshot of the image according to a second screenshot signal when the successive screenshot function is enabled, where the second screenshot signal is different from the first screenshot signal.

The disclosure further provides another screenshot method, applicable to an electronic device. The electronic device includes an input unit and a touch screen, and the touch screen is configured to display an image. The screenshot method includes: receiving a first screenshot signal using the input unit or the touch screen; taking a screenshot of the image according to a first screenshot signal, and enabling a successive screenshot function; and selecting one of an interactive screenshot function and a scheduling screenshot function according to a successive screenshot selection signal when the successive screenshot function is enabled, where the interactive screenshot function is taking a screenshot of the image according to a second screenshot signal, and the second screenshot signal is different from the first screenshot signal.

The disclosure further provides an electronic device. The electronic device includes an input unit, a touch screen, a screenshot unit, and a processing unit. The input unit is configured to receive a first screenshot signal. The touch screen is configured to display an image. The screenshot unit is configured to capture an image. The processing unit is configured to: control the screenshot unit to take a screenshot of the image according to the first screenshot signal, and selectively enable a successive screenshot function according to the first screenshot signal; and control the screenshot unit to take a screenshot of the image according to a second screenshot signal when the successive screenshot function is enabled, where the second screenshot signal is different from the first screenshot signal.

A computer program product is provided, where the computer program product is loaded by a computer to execute a first program instruction and a second program instruction. The first program instruction is calling a screenshot instruction to take a screenshot of a touch screen according to a first screenshot signal, and selectively enabling a successive screenshot function according to the first screenshot signal. The second program instruction is calling the screenshot instruction to take a screenshot of the touch screen according to a second screenshot signal when the successive screenshot function is enabled, where the first screenshot signal is different from the second screenshot signal.

Through the screenshot method, the electronic device, and the computer program product thereof provided in the disclosure, after a successive touch function is enabled, a user takes a screenshot easily by inputting the second screenshot signal through the touch screen, thereby simplifying the operation procedure of the user and also avoiding causing interference to other operations of the user.

### BRIEF DESCRIPTION OF THE DRAWINGS

FIG. 1 is a flowchart of a screenshot method according to an embodiment of the disclosure;

FIG. 2 shows an embodiment of step S12 in FIG. 1;

FIG. 3 is a flowchart of a screenshot method according to another embodiment of the disclosure;

FIG. 4 is a flowchart of a screenshot method according to still another embodiment of the disclosure; and

FIG. 5 is a schematic block diagram of an electronic device according to an embodiment of the disclosure.

### DETAILED DESCRIPTION OF THE EMBODIMENTS

Specific embodiments of the disclosure will be described in more detail below in combination with the accompanying drawings. The advantages and features of the disclosure become clearer based on the following description and the appended claims. It should be noted that the drawings are in a very simplified form and a non-precise scale, and are only intended to explain the objective of embodiments of the disclosure in a convenient and clear way.

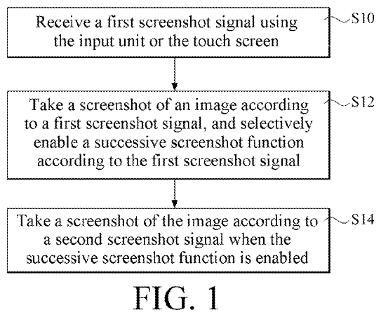

FIG. 1 is a flowchart of a screenshot method according to an embodiment of the disclosure. The screenshot method is used for taking a screenshot of an image of a touch screen, and is applicable to an electronic device with a touch screen, such as a notebook computer, a tablet computer, or a smartphone. The electronic device is further arranged with an input unit, such as a touchpad, a key, a touch sensor, or a pressure sensor, for a user to operate.

The screenshot method includes the following steps.

First, as described in step S10, a first screenshot signal is received using the input unit or the touch screen. Then, as described in step S12, a screenshot of an image is taken according to a first screenshot signal, and a successive screenshot function is selectively enabled according to the first screenshot signal. In an embodiment, the first screenshot signal is a multi-touch signal or a specific gesture signal of the touch screen. Further, the first screenshot signal is a signal generated when multiple keys are pressed at the same time (for example, a power key and a volume key are pressed at the same time), a signal of double-tapping a back cover of a mobile phone, or the like. In an embodiment, the first screenshot signal is a screenshot operation signal preset in the electronic device.

As described in step S14, when the successive screenshot function is enabled, a screenshot of the image is taken according to a second screenshot signal. The second screenshot signal is different from the first screenshot signal. In an embodiment, the second screenshot signal is a touch signal and generated by the touch screen.

In an embodiment, when the successive screenshot function is enabled, a screenshot of the image is taken only according to the second screenshot signal in the electronic device, and the first screenshot signal is disabled.

Compared with the first screenshot signal, the second screenshot signal is a simpler signal and is easy to input, to facilitate the user to take a screenshot. In an embodiment, the second screenshot signal is formed by a succession of a contacting screen signal and a leaving screen signal. In an embodiment, the second screenshot signal is formed by a succession of a contacting screen signal, a leaving screen signal, and a blank signal. A duration of the blank signal is greater than a preset time, such as two seconds, to avoid erroneous determining.

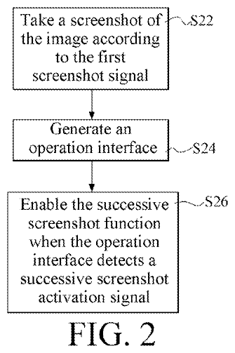

Referring to FIG. 2 together, FIG. 2 shows an embodiment of step S12 in FIG. 1.

First, as described in step S22, a screenshot of the image is taken according to the first screenshot signal.

Then, as described in step S24, an operation interface is generated. The operation interface is presented on the touch screen to remind the user whether to enable the successive screenshot function. The user determines whether to enable the successive screenshot function according to the operation interface. In an embodiment, the operation interface is a pop-up window with a selection key. Further, in an embodiment, the operation interface is also for the user to input a related parameter of the successive screenshot function, such as: a successive screenshot duration, a successive screenshot count, and a successive screenshot time interval.

Then, as described in step S26, when the operation interface detects a successive screenshot enabling signal, the successive screenshot function is enabled. In an embodiment, the successive screenshot enabling signal corresponds to a selection key on the operation interface. In an embodiment, in step S26, a notification image, such as a notification, corresponding to the successive screenshot function is further generated, to remind the user that the successive screenshot function is enabled.

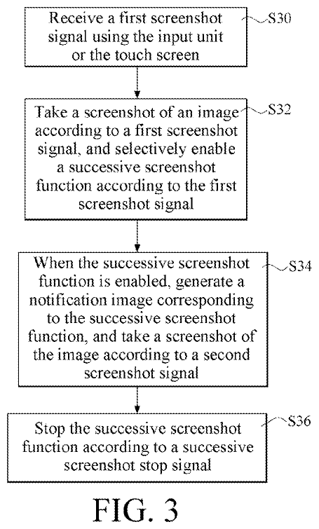

Referring to FIG. 3 together, FIG. 3 is a flowchart of a screenshot method according to another embodiment of the disclosure.

First, as described in step S30, a first screenshot signal is received using the input unit or the touch screen.

Then, as described in step S32, a screenshot of an image is taken according to a first screenshot signal, and a successive screenshot function is selectively enabled according to the first screenshot signal.

As described in step S34, when the successive screenshot function is enabled, a notification image corresponding to the successive screenshot function is generated, and a screenshot of the image is taken according to a second screenshot signal. The second screenshot signal is different from the first screenshot signal, to avoid erroneous determining. In an embodiment, the notification image is a notification, for reminding the user that the successive screenshot function is enabled.

Then, as described in step S36, the successive screenshot function is stopped according to a successive screenshot stop signal. The successive screenshot stop signal is different from the second screenshot signal, to avoid erroneous determining.

In an embodiment, the user directly taps the notification image generated in step S34 to input the successive screenshot stop signal. In an embodiment, after the successive screenshot function is stopped, the electronic device generates a notification image, and stores an image file obtained by taking a screenshot in a pre-specified folder. In this embodiment, when to stop the successive screenshot function is determined according to whether the successive screenshot stop signal is received. In other embodiments, when the successive screenshot function is enabled, a successive screenshot condition, such as a preset screenshot duration, a preset screenshot count, or a preset screenshot time interval, is set to determine when to stop the successive screenshot function. Further, in other embodiments, the successive screenshot function is stopped when the successive screenshot condition is met or the successive screenshot stop signal is received.

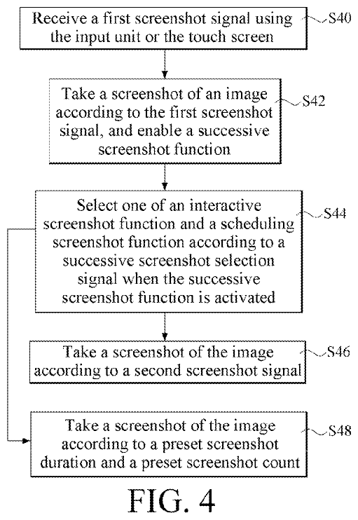

FIG. 4 is a flowchart of a screenshot method according to still another embodiment of the disclosure. The screenshot method is applicable to an electronic device with a touch screen, such as a notebook computer, a tablet computer, or a smartphone. The touch screen is configured to display an image. The electronic device is further arranged with an input unit, such as a touchpad, a key, a touch sensor, or a pressure sensor, for a user to operate.

The screenshot method includes the following steps.

First, as described in step S40, a first screenshot signal is received using the input unit or the touch screen. Then, as described in step S42, a screenshot of the image is taken according to the first screenshot signal, and a successive screenshot function is enabled.

As described in step S44, when the successive screenshot function is enabled, one of an interactive screenshot function and a scheduling screenshot function is selected according to a successive screenshot selection signal.

In step S44, when the interactive screenshot function is selected, the flow goes to step S46. As described in step S46, in the screenshot method in the disclosure, a screenshot of the image is taken according to a second screenshot signal, where the second screenshot signal is different from the first screenshot signal. The interactive screenshot function is similar to the screenshot function performed in step S14 in FIG. 1 or step S34 in FIG. 3, and details are not repeated herein.

In step S44, when the scheduling screenshot function is selected, the flow goes to step S48. As described in step S48, in the screenshot method in the disclosure, a screenshot of the image is taken according to a preset screenshot duration or a preset screenshot count.

Unlike the interactive screenshot function in which a time point of taking a screenshot of the touch screen is determined according to the second screenshot signal, the scheduling screenshot function is taking a screenshot of the image of the touch screen according to the preset screenshot duration or the preset screenshot count. In an embodiment, the scheduling screenshot function is set to take a screenshot at a fixed preset screenshot time interval within 30 minutes (the preset screenshot duration). Alternatively, the scheduling screenshot function is set to take a screenshot for 30 times (the preset screenshot count) at a fixed preset screenshot time interval.

In other embodiments, the scheduling screenshot function is also taking a screenshot of the image of the touch screen according to a preset screenshot duration and a preset screenshot count. Further, in other embodiments, the scheduling screenshot function is also not set with a screenshot duration or a preset screenshot count, but successively taking screenshots according to a fixed preset screenshot time interval. The successive screenshot function is not stopped until the successive screenshot stop signal is detected (as described in step S36).

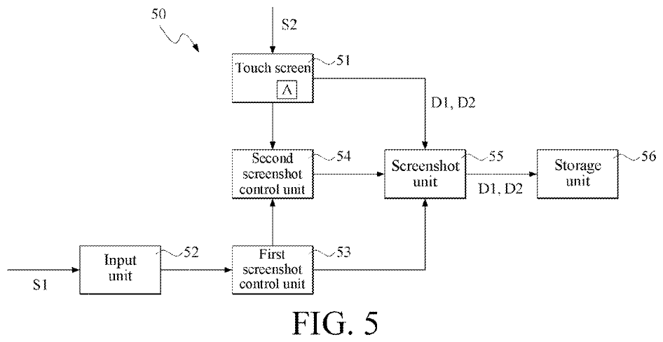

FIG. 5 is a schematic block diagram of an electronic device 50 according to an embodiment of the disclosure. As shown in the figure, the electronic device 50 includes a touch screen 51 and an input unit 52. The touch screen 51 is configured to display an image A. In an embodiment, the electronic device 50 is a notebook computer, a tablet computer, or a smartphone.

As shown in the figure, the electronic device 50 further includes a first screenshot control unit 53, a second screenshot control unit 54, a screenshot unit 55, and a storage unit 56.

The first screenshot control unit 53 controls the screenshot unit 55 according to a first screenshot signal S1 from the input unit 52 or the touch screen 51, to capture the image of the touch screen 51 to generate single screenshot image data D1. The first screenshot control unit 53 further enables the second screenshot control unit 54 according to the first screenshot signal S1.

The second screenshot control unit 54 is configured to perform a successive screenshot function. After the first screenshot control unit 53 enables the second screenshot control unit 54, the second screenshot control unit 54 controls the screenshot unit 55 according to a second screenshot signal S2 from the touch screen 51, to capture the image of the touch screen 51 to generate successive screenshot image data D2. The second screenshot signal S2 is different from the first screenshot signal S1. In an embodiment, after the second screenshot control unit 54 is enabled, the first screenshot control unit 53 stops operation automatically.

The input unit 52 is an input device of a human-computer interface, such as a touchpad, a key, a touch sensor, or a pressure sensor. The first screenshot signal S1 is alternatively a signal from the touch screen 51.

The storage unit 56 is configured to store the single screenshot image data D1 and the successive screenshot image data D2 generated by the screenshot unit 55. In an embodiment, the storage unit 56 stores the single screenshot image data D1 and the screenshot image data D2 into different folders.

In an embodiment, the first screenshot control unit 53, the second screenshot control unit 54, and the screenshot unit 55 are software programs performed by a processor, and the storage unit 56 is a storage medium such as a hard disk, a compact disc, a flash memory, or a solid state disk (SSD).

The disclosure further provides a computer program product, where the computer program product is loaded by a computer to execute: a first program instruction, calling a screenshot instruction to take a screenshot of a touch screen according to a first screenshot signal, and selectively enabling a successive screenshot function according to the first screenshot signal; and a second program instruction, calling a screenshot instruction to take a screenshot of the touch screen according to a second screenshot signal when the successive screenshot function is enabled. The second screenshot signal is different from the first screenshot signal. In an embodiment, the second screenshot signal S2 is a touch signal, and generated by the touch screen 51. The first screenshot signal S1 is not only a signal from the touch screen 51, but also a signal from another input device, such as a touchpad, a key, a touch sensor, a pressure sensor, of a human-computer interface.

Through the screenshot method provided in the disclosure, after a successive touch function is enabled, a user takes a screenshot easily by inputting the second screenshot signal S2 through the touch screen 51, without complex screenshot operations. This not only simplifies the operation procedure of the user, but also avoids causing interference to other operations of the user. In addition, according to an embodiment of the disclosure, in the screenshot method provided in the disclosure, after the user enables the successive touch function, an interactive screenshot function or a scheduling screenshot function is selected according to the demand, which provides the user with more choices in use.

The above are only preferred embodiments of the disclosure, and do not limit the disclosure in any way. Any person skilled in the art making any form of equivalent replacement or modification to the technical means and technical content disclosed in the disclosure, within the scope of the technical means of the disclosure, does not deviate from the content of the technical means of the disclosure, and still falls within the scope of protection of the disclosure.

What is claimed is:

1. A screenshot method, applicable to an electronic device, wherein the electronic device comprises an input unit and a touch screen, the touch screen is configured to display an image, and the screenshot method comprises:
receiving a first screenshot signal using the input unit or the touch screen;
taking a screenshot of the image according to the first screenshot signal, and selectively enabling a successive screenshot function according to the first screenshot signal; and
taking a screenshot of the image according to a second screenshot signal when the successive screenshot function is enabled, wherein the second screenshot signal is different from the first screenshot signal.

2. The screenshot method according to claim 1, wherein the step of selectively enabling the successive screenshot function according to the first screenshot signal comprises:
generating an operation interface; and
enabling the successive screenshot function when the operation interface detects a successive screenshot enabling signal.

3. The screenshot method according to claim 1, wherein the second screenshot signal is a touch signal generated by the touch screen.

4. The screenshot method according to claim 3, wherein the second screenshot signal is formed by a succession of a contacting screen signal and a leaving screen signal.

5. The screenshot method according to claim 1, wherein the step of taking a screenshot of the image according to the second screenshot signal is taking a screenshot of the image according to the second screenshot signal within a preset screenshot duration.

6. The screenshot method according to claim 1, further comprising stopping the successive screenshot function according to a successive screenshot stop signal.

7. A screenshot method, applicable to an electronic device, wherein the electronic device comprises an input unit and a touch screen, the touch screen is configured to display an image, and the screenshot method comprises:
receiving a first screenshot signal using the input unit or the touch screen;
taking a screenshot of the image according to a first screenshot signal, and enabling a successive screenshot function; and
selecting one of an interactive screenshot function and a scheduling screenshot function according to a successive screenshot selection signal when the successive screenshot function is enabled,
wherein the interactive screenshot function is taking a screenshot of the image according to a second screenshot signal, and the second screenshot signal is different from the first screenshot signal.

8. The screenshot method according to claim 7, wherein the scheduling screenshot function is taking a screenshot of the image according to a preset screenshot duration or a preset screenshot count.

9. An electronic device, comprising:
an input unit, configured to receive a first screenshot signal;
a touch screen, configured to display an image;
a screenshot unit, configured to capture the image; and
a processing unit, configured to:
control the screenshot unit to take a screenshot of the image according to the first screenshot signal, and selectively enable a successive screenshot function according to the first screenshot signal; and
control the screenshot unit to take a screenshot of the image according to a second screenshot signal when the successive screenshot function is enabled, wherein the second screenshot signal is different from the first screenshot signal.

10. The electronic device according to claim 9, wherein the second screenshot signal is a touch signal generated by the touch screen.

11. A computer program product, wherein the computer program product is loaded by a computer to execute:
a first program instruction, calling a screenshot instruction to take a screenshot of an image according to a first screenshot signal, and selectively enabling a successive screenshot function according to the first screenshot signal; and
a second program instruction, calling the screenshot instruction to take a screenshot of the image according to a second screenshot signal when the successive screenshot function is enabled, wherein the first screenshot signal is different from the second screenshot signal.
